(19) United States
(12) Patent Application Publication
(10) Pub. No.: US 2017/0201905 A1
(43) Pub. Date: Jul. 13, 2017

(54) STATION (STA) AND METHOD FOR COMMUNICATION IN ACCORDANCE WITH BLOCK ACKNOWLEDGEMENT (BA)

(71) Applicants: Solomon B. Trainin, Haifa (IL); Carlos Cordeiro, Portland, OR (US)

(72) Inventors: Solomon B. Trainin, Haifa (IL); Carlos Cordeiro, Portland, OR (US)

(21) Appl. No.: 15/086,625

(22) Filed: Mar. 31, 2016

Related U.S. Application Data
(60) Provisional application No. 62/276,048, filed on Jan. 7, 2016.

(51) Int. Cl. H04W 28/06; H04W 72/04; H04L 1/16

(52) U.S. Cl. CPC H04W 28/065; H04L 1/1621; H04W 72/0413

(57) ABSTRACT

Embodiments of a station (STA) and method for communication in accordance with block acknowledgement (BA) are generally described herein. An originating STA may transmit a block acknowledgement (BA) setup message to a receiving STA that indicates a maximum medium access control (MAC) protocol data unit (MPDU) size for a data session. The maximum MPDU size may be determined as part of a negotiation of a BA procedure. The originating STA may aggregate, in accordance with the maximum MPDU size, one or more groups of MAC service data units (MSDUs) for inclusion in a group of MPDUs for transmission to the receiving STA. The receiving STA may transmit, to the originating STA, a multiple traffic identifier (multi-TID) BA message to indicate whether the MPDUs have been successfully decoded at the receiving STA.

### PRIORITY CLAIM

This application claims priority under 35 USC 119(e) to U.S. Provisional Patent Application Ser. No. 62/276,048, filed Jan. 7, 2016 [reference number P95185Z (4884.494PRV)] which is incorporated herein by reference in its entirety.

### TECHNICAL FIELD

Embodiments pertain to wireless networks. Some embodiments relate to wireless local area networks (WLANs) and Wi-Fi networks including networks operating in accordance with the IEEE 802.11 family of standards. Some embodiments relate to networks operating in accordance with IEEE 802.11ay. Some embodiments relate to Third Generation Partnership Project (3GPP) networks, including 3GPP Long Term Evolution (LTE) networks.

### BACKGROUND

In a mobile network, a mobile device may communicate with a base station and/or another mobile device for exchanging of data, such as video. Performance of the mobile device may be affected by any number of factors. As an example, as a data rate increases, the link access overhead may become even more challenging in some cases. Accordingly, there is a general need for methods and systems that address these high data rate scenarios and other scenarios.

### BRIEF DESCRIPTION OF THE DRAWINGS

FIG. 1 illustrates a wireless network in accordance with some embodiments;

FIG. 2 illustrates an example machine in accordance with some embodiments;

FIG. 3 illustrates a station (STA) in accordance with some embodiments and an access point (AP) in accordance with some embodiments;

FIG. 4 illustrates the operation of a method of communication in accordance with some embodiments;

FIG. 5 illustrates examples of link utilization (LU) in accordance with some embodiments;

FIG. 6 illustrates examples of Information Elements (IEs) in accordance with some embodiments;

FIG. 7 illustrates examples of Block Acknowledgement (BA) frames and control fields in accordance with some embodiments;

FIG. 8 illustrates BA bitmap examples in accordance with some embodiments;

FIG. 9 illustrates examples of BA frame variant encoding in accordance with some embodiments; and

FIG. 10 illustrates the operation of another method of communication in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

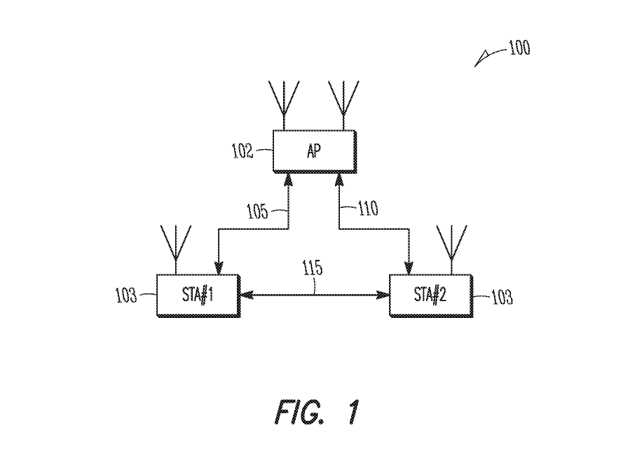

FIG. 1 illustrates a wireless network in accordance with some embodiments. In some embodiments, the network 100 may be a Wireless Local Area Network (WLAN) or a Wi-Fi network, although the scope of embodiments is not limited in this respect. It should be noted that embodiments are not limited to the number or type of components shown in the example network 100. Embodiments are also not limited by the example network 100 in terms of the arrangement of the components or the connectivity between components as shown. In addition, some embodiments may include additional components.

The example network 100 may include one or more access points (APs) 102 in some embodiments, although the scope of embodiments is not limited in this respect. Some embodiments may not necessarily include an AP 102. The example network may include one or more stations (STAs) 103. In some embodiments, the STAs 103 and/or AP 102 may be arranged to operate in accordance with one or more IEEE 802.11 standards, including but not limited to 802.11ay. In some embodiments, an AP 102 may be configurable to operate as an AP 102 and/or as an STA 103.

Embodiments are not limited to usage of APs 102 and/or STAs 103, however, as other base station components and/or mobile devices, which may or may not be arranged to operate in accordance with a standard, may be used in some embodiments. As an example, an Evolved Node-B (eNB) and/or User Equipment (UE) arranged to operate in accordance with one or more Third Generation Partnership Project (3GPP) standards, including but not limited to 3GPP Long Term Evolution (LTE) standards, may be used in some cases.

In some embodiments, the STAs 103 may be configured to communicate with the AP 102 and/or with other STAs 103. As shown in the example network 100 in FIG. 1, STA #1 may communicate with the AP 102 over the wireless link 105 and STA #2 may communicate with the AP 102 over the wireless link 110. In some embodiments, direct communication between STAs 103 may be possible, such as over the wireless link 115 between STA #1 and STA #2. These embodiments are not limiting, however, as the direction communication between STAs 103 may not necessarily be possible in some embodiments.

In some embodiments, the communication between the AP 102 and the STAs 103 and/or the communication between the STAs 103 may be performed in accordance with one or more standards, such as an 802.11 standard (including 802.11ay and/or legacy 802.11 standards), a 3GPP standard (including 3GPP LTE standards) and/or other standards. These embodiments are not limiting, however, as other communication techniques and/or protocols, which may or may be included in a standard, may be used for the communication between the AP 102 and the STAs 103 and/or the communication between the STAs 103, in some embodiments.

In accordance with some embodiments, an originating STA 103 (such as STA #1) may transmit medium access control (MAC) protocol data units (MPDUs) to a receiving STA 103 (such as STA #2). The receiving STA 103 may transmit one or more block acknowledgement (BA) messages to the originating STA 103 that may indicate whether MPDUs have been successfully received at the receiving STA 103. These embodiments will be described in more detail below.

It should be noted that the STAs 103, the AP 102, mobile devices, base stations and/or other devices may be configured to operate in various frequency bands, including but not limited to millimeter wave (mmWave), ultra high frequency (UHF), microwave and/or other frequency bands. As an example, a frequency band that includes a 60 GHz frequency may be used in some cases. As another example, the frequency band may be located near the 60 GHz frequency. These examples are not limiting, however, as any suitable frequency band may be used in some embodiments.

In some embodiments, the STAs 103, AP 102, other mobile devices, other base stations and/or other devices may be configured to perform operations related to contention based communication. As an example, the communication between the STAs 103 and/or AP 102 and/or the communication between the STAs 103 may be performed in accordance with contention based techniques. In such cases, the STAs 103 and/or AP 102 may be arranged to contend for a wireless medium (e.g., during a contention period) to receive exclusive control of the medium for a transmission period. For instance, the transmission period may include a transmission opportunity (TXOP), which may be referred to in an 802.11 standard and/or other standard, or may be included in an 802.11 standard and/or other standard.

It should be noted that embodiments are not limited to usage of contention based techniques, however, as some communication (such as that between mobile devices and/or communication between a mobile device and a base station) may be performed in accordance with schedule based techniques. Some embodiments may include a combination of contention based techniques and schedule based techniques.

In some embodiments, the communication between mobile devices and/or between a mobile device and a base station may be performed in accordance with any suitable multiple-access techniques and/or multiplexing techniques. Accordingly, one or more of carrier sense multiple access with collision avoidance (CSMA/CA), orthogonal frequency division multiple access (OFDMA), orthogonal frequency division multiplexing (OFDM), code-division multiple access (CDMA), time-division multiple access (TDMA), frequency division multiplexing (FDMA), space-division multiple access (SDMA), multiple-input multiple-output (MIMO), multi-user (MU) multiple-input multiple-output (MIMO) (MU-MIMO) and/or other techniques may be employed in some embodiments.

In some embodiments, channels used for communication between STAs 103 and/or APs 102 may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, subchannel bandwidths less than 20 MHz may also be used. In some embodiments, channels of bandwidth of 2.16 GHz and/or multiples of 2.16 GHz may be used. For instance, communication in a 60 GHz band may include usage of channels of bandwidth of 2.16 GHz and/or multiples of 2.16 GHz, in some cases. In some embodiments, each channel or subchannel may be configured for transmitting a number of spatial streams. It should be noted that the bandwidths described above are not limiting, as other suitable bandwidths may be used in some embodiments.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware and/or software.

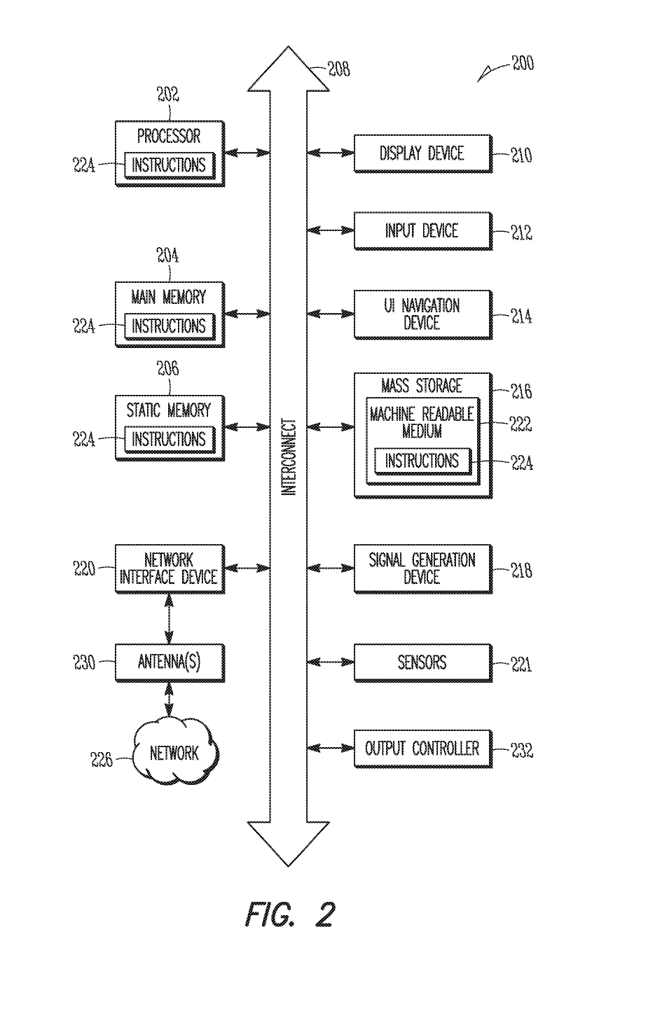

FIG. 2 illustrates a block diagram of an example machine in accordance with some embodiments. The machine 200 is an example machine upon which any one or more of the techniques and/or methodologies discussed herein may be performed. In alternative embodiments, the machine 200 may operate as a standalone device or may be connected (e.g., networked) to other machines. In a networked deployment, the machine 200 may operate in the capacity of a server machine, a client machine, or both in server-client network environments. In an example, the machine 200 may act as a peer machine in peer-to-peer (P2P) (or other distributed) network environment. The machine 200 may be an AP 102, STA 103, UE, eNB, mobile device, base station, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The machine (e.g., computer system) 200 may include a hardware processor 202 (e.g., a central processing unit (CPU), a graphics processing unit (GPU), a hardware processor core, or any combination thereof), a main memory 204 and a static memory 206, some or all of which may communicate with each other via an interlink (e.g., bus) 208. The machine 200 may further include a display unit 210, an alphanumeric input device 212 (e.g., a keyboard), and a user interface (UI) navigation device 214 (e.g., a mouse). In an example, the display unit 210, input device 212 and UI navigation device 214 may be a touch screen display. The machine 200 may additionally include a storage device (e.g., drive unit) 216, a signal generation device 218 (e.g., a speaker), a network interface device 220, and one or more sensors 221, such as a global positioning system (GPS) sensor, compass, accelerometer, or other sensor. The machine 200 may include an output controller 228, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a machine readable medium 222 on which is stored one or more sets of data structures or instructions 224 (e.g., software) embodying or utilized by any one or more of the techniques or functions described herein. The instructions 224 may also reside, completely or at least partially, within the main memory 204, within static memory 206, or within the hardware processor 202 during execution thereof by the machine 200. In an example, one or any combination of the hardware processor 202, the main memory 204, the static memory 206, or the storage device 216 may constitute machine readable media. In some embodiments, the machine readable medium may be or may include a non-transitory computer-readable storage medium.

While the machine readable medium 222 is illustrated as a single medium, the term “machine readable medium” may include a single medium or multiple media (e.g., a centralized or distributed database, and/or associated caches and servers) configured to store the one or more instructions 224. The term “machine readable medium” may include any medium that is capable of storing, encoding, or carrying instructions for execution by the machine 200 and that cause the machine 200 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 224 may further be transmitted or received over a communications network 226 using a transmission medium via the network interface device 220 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 220 may include one or more physical jacks (e.g., Ethernet, coaxial, or phone jacks) or one or more antennas to connect to the communications network 226. In an example, the network interface device 220 may include a plurality of antennas to wirelessly communicate using at least one of single-input multiple-output (SIMO), multiple-input multiple-output (MIMO), or multiple-input single-output (MISO) techniques. In some examples, the network interface device 220 may wirelessly communicate using Multiple User MIMO techniques. The term “transmission medium” shall be taken to include any intangible medium that is capable of storing, encoding or carrying instructions for execution by the machine 200, and includes digital or analog communications signals or other intangible medium to facilitate communication of such software.

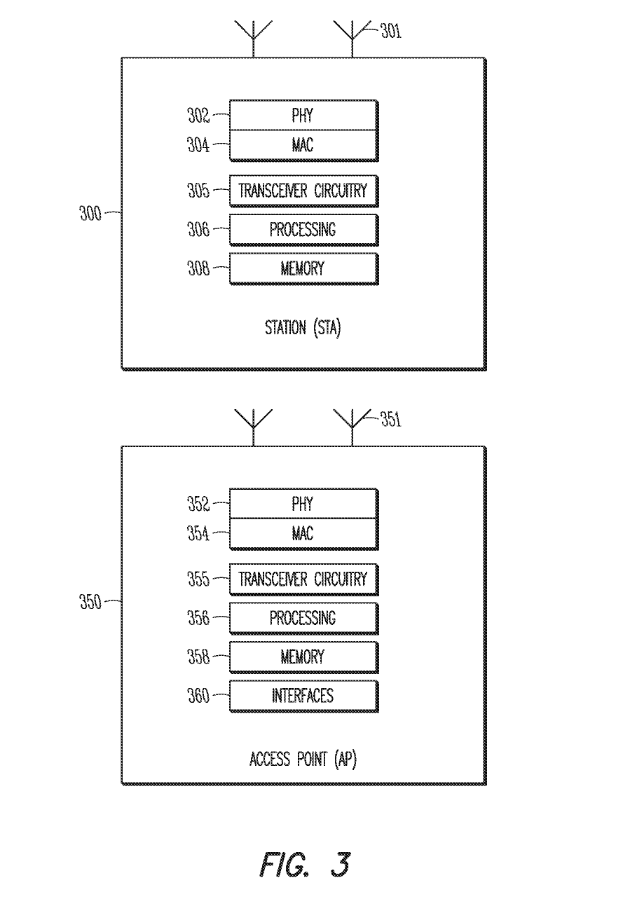

FIG. 3 illustrates a station (STA) in accordance with some embodiments and an access point (AP) in accordance with some embodiments. It should be noted that in some embodiments, an STA or other mobile device may include some or all of the components shown in either FIG. 2 or FIG. 3 (as in 300) or both. The STA 300 may be suitable for use as an STA 103 as depicted in FIG. 1, in some embodiments. It should also be noted that in some embodiments, an AP or other base station may include some or all of the components shown in either FIG. 2 or FIG. 3 (as in 350) or both. The AP 300 may be suitable for use as an AP 103 as depicted in FIG. 1, in some embodiments.

The STA 300 may include physical layer circuitry 302 and a transceiver 305, one or both of which may enable transmission and reception of signals to and from components such as the AP 102 (FIG. 1), other STAs or other devices using one or more antennas 301. As an example, the physical layer circuitry 302 may perform various encoding and decoding functions that may include formation of baseband signals for transmission and decoding of received signals. As another example, the transceiver 305 may perform various transmission and reception functions such as conversion of signals between a baseband range and a Radio Frequency (RF) range. Accordingly, the physical layer circuitry 302 and the transceiver 305 may be separate components or may be part of a combined component. In addition, some of the described functionality related to transmission and reception of signals may be performed by a combination that may include one, any or all of the physical layer circuitry 302, the transceiver 305, and other components or layers. The STA 300 may also include medium access control layer (MAC) circuitry 304 for controlling access to the wireless medium. The STA 300 may also include processing circuitry 306 and memory 308 arranged to perform the operations described herein.

The AP 350 may include physical layer circuitry 352 and a transceiver 355, one or both of which may enable transmission and reception of signals to and from components such as the STA 103 (FIG. 1), other APs or other devices using one or more antennas 351. As an example, the physical layer circuitry 352 may perform various encoding and decoding functions that may include formation of baseband signals for transmission and decoding of received signals. As another example, the transceiver 355 may perform various transmission and reception functions such as conversion of signals between a baseband range and a Radio Frequency (RF) range. Accordingly, the physical layer circuitry 352 and the transceiver 355 may be separate components or may be part of a combined component. In addition, some of the described functionality related to transmission and reception of signals may be performed by a combination that may include one, any or all of the physical layer circuitry 352, the transceiver 355, and other components or layers. The AP 350 may also include medium access control layer (MAC) circuitry 354 for controlling access to the wireless medium. The AP 350 may also include processing circuitry 356 and memory 358 arranged to perform the operations described herein.

The antennas 301, 351, 230 may comprise one or more directional or omnidirectional antennas, including, for example, dipole antennas, monopole antennas, patch antennas, loop antennas, phase array antennas, microstrip antennas or other types of antennas suitable for transmission of RF signals. In some multiple-input multiple-output (MIMO) embodiments, the antennas 301, 351, 230 may be effectively separated to take advantage of spatial diversity and the different channel characteristics that may result.

In some embodiments, the STA 300 and/or AP 350 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly. In some embodiments, the STA 300 and/or AP 350 may be configured to operate in accordance with 802.11 standards, although the scope of the embodiments is not limited in this respect. Mobile devices or other devices in some embodiments may be configured to operate according to other protocols or standards, including other IEEE standards, Third Generation Partnership Project (3GPP) standards or other standards. In some embodiments, the STA 300 and/or AP 350 may include one or more of a keyboard, a display, a non-volatile memory port, multiple antennas, a graphics processor, an application processor, speakers, and other mobile device elements. The display may be an LCD screen including a touch screen.

Although the STA 300 and the AP 350 are each illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus used by the STA 300 may include various components of the STA 300 as shown in FIG. 3 and/or the example machine 200 as shown in FIG. 2. Accordingly, techniques and operations described herein that refer to the STA 300 (or 103) may be applicable to an apparatus for an STA, in some embodiments. It should also be noted that in some embodiments, an apparatus used by the AP 350 may include various components of the AP 350 as shown in FIG. 3 and/or the example machine 200 as shown in FIG. 2. Accordingly, techniques and operations described herein that refer to the AP 350 (or 102) may be applicable to an apparatus for an AP, in some embodiments. In addition, an apparatus for a mobile device and/or base station may include one or more components shown in FIGS. 2-3, in some embodiments. Accordingly, techniques and operations described herein that refer to a mobile device and/or base station may be applicable to an apparatus for a mobile device and/or base station, in some embodiments.

In some embodiments, the STA 300, AP 350, mobile device and/or base station may communicate using OFDM communication signals over a multicarrier communication channel. Accordingly, in some cases the STA 300, AP 350, mobile device and/or base station may be configured to receive signals in accordance with specific communication standards, such as the Institute of Electrical and Electronics Engineers (IEEE) standards including IEEE 802.11-2012, 802.11n-2009 and/or 802.11ac-2013 standards and/or proposed specifications for WLANs including proposed HEW standards, although the scope of the embodiments is not limited in this respect as they may also be suitable to transmit and/or receive communications in accordance with other techniques and standards. In some other embodiments, the STA 300, AP 350, mobile device and/or base station may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, frequency-division multiplexing (FDM) modulation and/or single carrier frequency-division multiplexing (SC-FDM) although the scope of the embodiments is not limited in this respect.

In accordance with some embodiments, an originating STA 103 may transmit, to a receiving STA 103, a block acknowledgement (BA) setup message that indicates a maximum medium access control (MAC) protocol data unit (MPDU) size for a data session with the receiving STA. The maximum MPDU size may be determined as part of a negotiation of a BA procedure to be used as part of the data session. The originating STA 103 may aggregate, in accordance with the maximum MPDU size, one or more groups of MAC service data units (MSDUs) for inclusion in a group of MPDUs for transmission to the receiving STA 103 as part of the data session. The receiving STA 103 may transmit, to the originating STA 103, a multiple traffic identifier (multi-TID) BA message to indicate whether the MPDUs have been successfully decoded at the receiving STA 103. These embodiments will be described in more detail below.

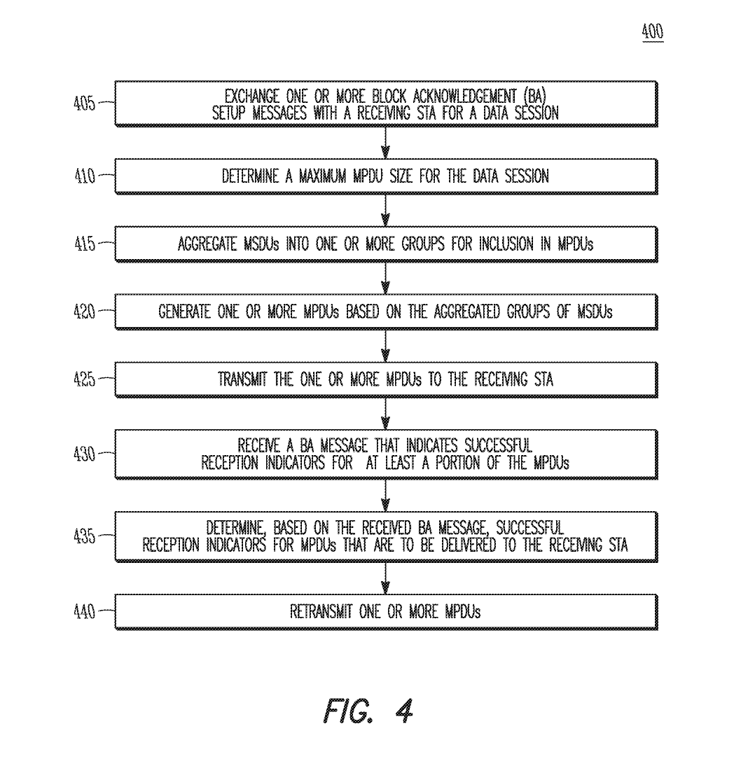

FIG. 4 illustrates the operation of a method of communication in accordance with some embodiments. It is important to note that embodiments of the method 400 may include additional or even fewer operations or processes in comparison to what is illustrated in FIG. 4. In addition, embodiments of the method 400 are not necessarily limited to the chronological order that is shown in FIG. 4. In describing the method 400, reference may be made to FIGS. 1-3 and 5-10, although it is understood that the method 400 may be practiced with any other suitable systems, interfaces and components.

In addition, the method 400 and other methods described herein may refer to STAs 103 and/or APs 102 operating in accordance with one or more standards and/or protocols, such as 802.11, Wi-Fi, wireless local area network (WLAN) and/or other, embodiments of those methods are not limited to just those devices. In some embodiments, the method 400 and other methods described herein may be practiced by other mobile devices, such as an HEW STA, an HEW AP, an Evolved Node-B (eNB) or User Equipment (UE). The method 400 and other methods described herein may also be practiced by wireless devices configured to operate in other suitable types of wireless communication systems, including systems configured to operate according to various Third Generation Partnership Project (3GPP) Long Term Evolution (LTE) standards. The method 400 may also be applicable to an apparatus for an STA 103 and/or AP 102 or other device described above, in some embodiments.

It should also be pointed out that reference may be made herein to an “originating STA 103” and/or “receiving STA 103.” For instance, an operation may include transmission of a signal from an originating STA 103 to a receiving STA 103. These references are not limiting, however. In some embodiments, an STA 103 may be configured to perform operations described herein for either an originating STA 103, a receiving STA 103 or both.

In some embodiments, communication between the STA 103 and an AP 102 may be performed in a frequency band that includes a 60 GHz frequency. In some embodiments, the frequency band may be or may include a millimeter wave (mmWave) frequency band. These embodiments are not limiting, however, as other frequency bands, including but not limited to ultra-high frequency (UHF) and/or microwave frequency bands, may be used in some embodiments.

It should also be noted that embodiments are not limited by references herein to transmission, reception and/or exchanging of frames, messages, and packets. In some embodiments, such a frame, message or packet may be generated by processing circuitry for transmission. The transmission may be performed by a transceiver or other component, in some cases. In some embodiments, such a frame, message or packet may be decoded, detected and/or processed by the processing circuitry. The frame, message or packet may be received by a transceiver or other component, in some cases. In some embodiments, the processing circuitry and the transceiver may be included in a same apparatus. The scope of embodiments is not limited in this respect, however, as the transceiver may be separate from the apparatus that comprises the processing circuitry, in some embodiments.

At operation 405 of the method 400, the originating STA 103 may exchange one or more Block Acknowledgement (BA) setup messages with a receiving STA 103 for a data session. Accordingly, the originating STA 103 and the receiving STA 103 may transmit one or more BA setup messages to each other and/or receive one or more BA setup messages from each other, in some cases. Any suitable BA setup messages may be used, including but not limited to example BA setup messages that will be presented below. In some embodiments, the BA setup messages may be exchanged as part of a negotiation of a BA procedure to be used for the data session.

At operation 410, a maximum medium access control (MAC) protocol data unit (MPDU) size for the data session may be determined. As an example, the determination of the maximum MPDU size may be part of the negotiation of the BA procedure, in some cases. In some embodiments, the originating STA 103 may determine the MPDU size and may indicate the maximum MPDU size to the receiving STA 103, although the scope of embodiments is not limited in this respect. In some embodiments, the maximum MPDU size may be determined cooperatively by the originating STA 103 and the receiving STA 103, such as during the negotiation of the BA procedure. In some embodiments, the originating STA 103 may transmit, to the receiving STA 103, a BA setup message that indicates the maximum MPDU size for the data session. Accordingly, the maximum MPDU size may be indicated by the BA setup message as part of the negotiation of the BA procedure to be used as part of the data session, in some embodiments. The maximum MPDU size may be a negotiated maximum MPDU size, in some cases.

As a non-limiting example, the maximum MPDU size may indicate a maximum number of bytes, bits, words or other that may be included by the originating STA 103 in an MPDU or in a payload of an MPDU. Accordingly, the maximum MPDU size may be indicated to enable memory allocation, at the receiving STA 103, for MPDUs transmitted by the originating STA 103 in the data session, in some embodiments. For instance, the receiving STA 103 may allocate memory in accordance with the maximum MPDU size. As a non-limiting example, an available memory may be divided into a number of buffers for which a size is approximately the maximum MPDU size. In some cases, such an allocation may be used instead of division of the memory into a number of buffers of a default size.

At operation 415, the originating STA 103 may aggregate groups of MAC service data units (MSDUs) for inclusion in MPDUs. In some embodiments, the MSDUs may be aggregated in accordance with the maximum MPDU size. At operation 420, one or more MPDUs may be generated based on the aggregated groups of MSDUs. As an example, an MPDU may include one or more headers and/or control information in addition to an aggregation of MSDUs. At operation 425, the originating STA 103 may transmit the one or more MPDUs to the receiving STA 103. Although embodiments are not limited as such, the MPDUs may be included in one or more physical layer service data unit (PSDU), which may be transmitted.

In some embodiments, the originating STA 103 may transmit one or more MPDUs to the receiving STA 103 as part of the data session. As an example, one or more MSDUs may be aggregated for inclusion in an MPDU. Accordingly, the MPDU may include an aggregation of one or more MSDUs. In addition, the MPDU may include one or more headers and/or fields that may include control information for the MPDU.

In some embodiments, one or more MPDUs may be aggregated for inclusion in a physical layer service data unit (PSDU), which may be transmitted to the receiving STA 103. Accordingly, the PSDU may include an aggregation of one or more MPDUs. In addition, the PSDU may include one or more headers and/or fields that may include control information for the PSDU. It should be noted that embodiments are not limited to usage of PSDUs for transmission of aggregations of MPDUs. In addition, the MSDUs, MPDUs and/or PSDUs may be used in accordance with an 802.11 standard and/or other standard in some cases, although the scope of embodiments is not limited in this respect.

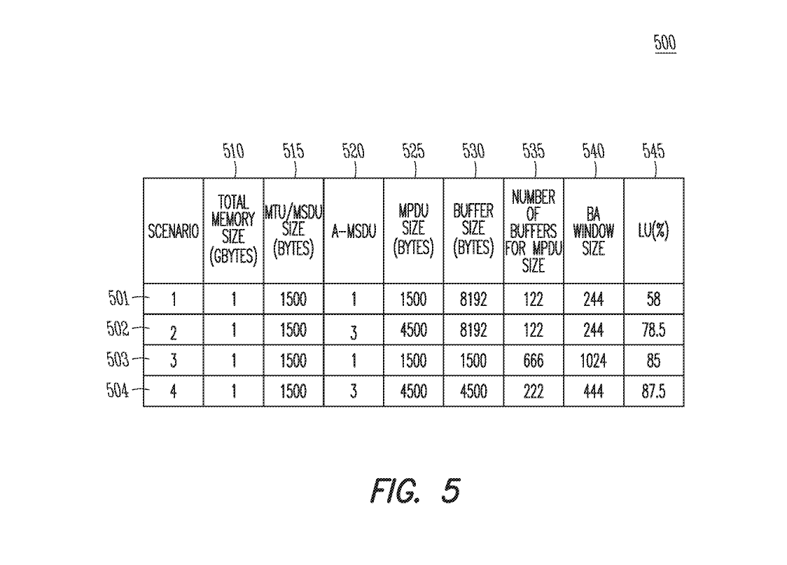

FIG. 5 illustrates examples of link utilization (LU) in accordance with some embodiments. It should be noted that the examples shown in FIG. 5 may serve to illustrate some or all of the concepts and techniques described herein, but embodiments are not limited by the LU examples. Embodiments are not limited by the number, size, type, arrangement and/or other aspects of the examples. For instance, embodiments are not limited to the memory size shown or to the packet sizes (such as MPDU sizes and/or MSDU sizes) shown.

Four example scenarios 501-504 are shown. In the example scenarios 501-504, a memory size of 1 Gbyte is available at the receiving STA 103, as indicated in column 510. In addition, for the scenarios 501-504, an MSDU size of 1500 bytes is used, as indicated by column 515. A number of MSDUs that may be aggregated per MPDU is shown in column 520 for the different scenarios. It should be noted that the values of 1 and 3 in column 520 are used as examples and embodiments are not limited to these values. Column 525 indicates a maximum MPDU size (a product of columns 515 and 520, in this case) for scenarios 501-504.

In the example scenarios 501 and 502, a buffer size of 8192 bytes is used, as indicated in column 530. For instance, the value of 8192 may be a default value in some cases. In the example scenarios 503 and 504, buffer sizes of 1500 and 4500 are used, as indicated in column 530. The usage of these buffer sizes may be in accordance with maximum MPDU sizes shown in column 525 for the scenarios 503 and 504, in some cases.

In column 535, a number of buffers that may be allocated for the MPDU size of column 530 is shown, and may be based on a division of the memory size in column 510 by the buffer size of column 530. The BA window size of column 540 may be based on a doubling of the number of buffers in column 535, in some cases.

Link utilization (LU) values for the scenarios 501-504 are shown in column 545. As shown in FIG. 5, scenario 503 may have a higher LU than scenario 501 in some cases, such as 85% in comparison to 58% in the example of FIG. 5. In addition, scenario 504 may have a higher LU than scenario 502 in some cases, such as 87.5% in comparison to 78.5% in the example of FIG. 5.

It should be noted that embodiments are not limited to any particular technique and/or formula used to determine the LU. As a non-limiting example, the LU may be determined as LU=[PSDU size (aggregated data MPDU)]/[(PSDU size (aggregated data MPDU)+PHY overhead)+SIFS*2+PPDU size], in some cases.

In some embodiments, an efficiency of a BA procedure may be measured as good-put at the MAC SAP, which may depend on the LU in some cases. In some cases, benefits to LU may be realized by increasing a size of the PSDU that delivers data and/or reducing, minimizing and/or maintaining BA overhead. In some cases, a size of an aggregated data PSDU may depend on memory available for buffering of received data frames, and LU may depend on an efficiency of such buffering and memory allocation.

As a non-limiting example, a BA setup message may be or may include an Add Block Acknowledgement (ADDBA) Request message. The ADDBA Request message may be negotiated per Traffic Identifier (TID), in some embodiments. The ADDBA Request message may include a maximum MPDU size Information Element (IE) that includes the maximum MPDU size. It should be noted that in some embodiments, different maximum MPDU sizes may be negotiated and/or used per each BA agreement. As another non-limiting example, a BA setup message may include an Add Traffic Stream (ADDTS) Request message that includes a traffic specification (TSPEC) Information Element (IE). The TSPEC IE may include a maximum MSDU size and a maximum number of MSDUs that may be aggregated for inclusion in the MPDU. In some embodiments, the maximum MSDU size and/or the maximum number of MSDUs may be negotiated per TID. Accordingly, the maximum MPDU size for the data session may be based at least partly on the maximum MSDU size and the maximum number of MSDUs. For instance, the maximum MPDU size may be based on a multiplication of the maximum MSDU size and the maximum number of MSDUs, in some cases.

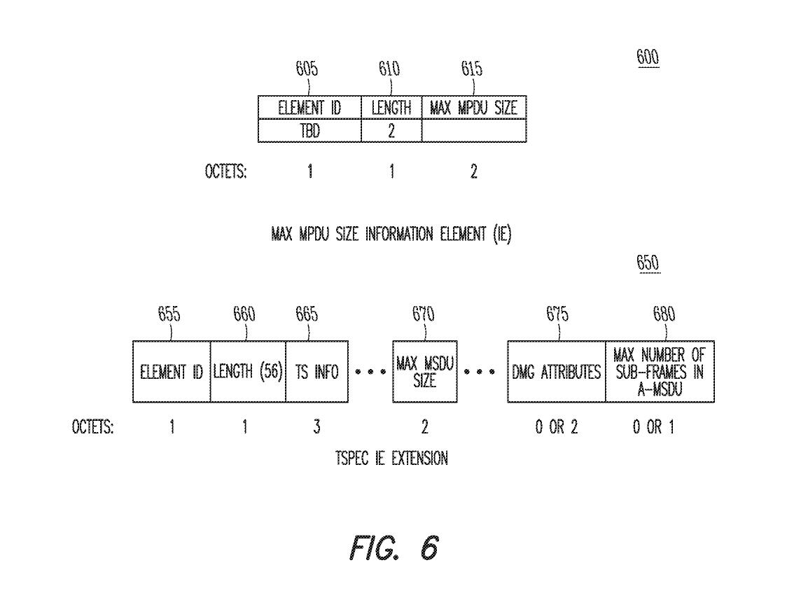

FIG. 6 illustrates examples of Information Elements (IEs) in accordance with some embodiments. The IEs 600 and 650 shown in FIG. 6 may illustrate some or all of the concepts described herein, but the scope of the embodiments is not limited by this example. In addition, formats, sizes and arrangements of the message and parameters as shown in FIG. 6 are also not limiting. Some embodiments may include any or all of the parameters shown in FIG. 6, and some embodiments may include additional parameters not shown in FIG. 6. Some embodiments may also include other similar parameters in addition to, or instead of, some of those parameters shown in FIG. 6.

As previously described, BA setup messages exchanged as part of the negotiation of the MPDU size may include IEs such as 600 and/or 650, in some embodiments. The example maximum MPDU size IE 600 may include an element ID 605, a length 610 and/or a maximum MPDU size 615. The length 610 may indicate a length of the MPDU size 615 and may be given in terms of any suitable unit, such as bits, bytes, octets or other. In addition, the maximum MPDU size 615 may indicate a number of bits, bytes, octets or other, in some cases.

The example TSPEC IE extension 650 may include a maximum MSDU size 670 and a maximum number of sub-frames in an A-MSDU 680. In some cases, the maximum number of MSDUs that may be aggregated into an MPDU may be included as 680. It should be noted that values for the maximum MSDU size may indicate a number of bits, bytes, octets or other, in some cases.

Returning to the method 400, at operation 430, the originating STA 103 may receive a BA message from the receiving STA 103. In some embodiments, the BA message may include an MPDU bitmap that may indicate, for a group of MPDUs transmitted from the originating STA 103 to the receiving STA 103, whether or not the receiving STA 103 was able to successfully decode the MPDUs in the group. As a non-limiting example, each bit of the MPDU bitmap may take a value of 1 or 0 to indicate successful or unsuccessful reception for a particular MPDU. The MPDUs indicated by the bits of the bitmap may be a sequence of MPDUs, in some cases. At operation 435, the originating STA 103 may determine successful reception indicators for MPDUs in the group based at least partly on the MPDU bitmap. At operation 440, the originating STA 103 may retransmit one or more MPDUs. As a non-limiting example, MPDUs for which the successful reception indicators indicate unsuccessful reception at the receiving STA 103 may be retransmitted. The MPDUs may be retransmitted using any suitable techniques, including but not limited to usage of PSDUs and/or other techniques described previously.

In some embodiments, the BA message may be or may include a multiple traffic identifier (multi-TID) BA message. As an example, an MPDU transmitted to the receiving STA 103 may belong to a traffic class (TC), which may be assigned a TID. In some cases, such as when quality-of-service (QoS) techniques are used, different TCs and therefore different TIDs may be possible. In some embodiments, the multi-TID BA message may be configurable to include multiple MPDU bitmaps and corresponding starting sequence numbers (SNs). The multiple MPDU bitmaps may be for different TIDs, in some cases, but embodiments are not limited as such. In some cases, multiple sequences of a same TID may be used in a same multi-TID BA message. Accordingly, the multi-TID BA message may include a group of MPDU bitmaps for different sequences of the decoded MPDUs. In some embodiments, TIDs of at least a portion of the sequences of the decoded MPDUs may be the same.

Accordingly, a number of available MPDU bitmaps may be allocated to one or more TIDs using any suitable combination. For instance, one or more MPDU bitmaps may be used for MPDUs of a first TID and one or more MPDU bitmaps may be used for MPDUs of a second TID. Two different MPDU bitmaps for a same TID may use different starting sequence numbers, in some cases.

As an example, SNs for the decoded MPDUs of each MPDU bitmap may be consecutive, and MPDU bitmaps may be restricted to a fixed length. For instance, bitmaps of 128 bits may be used for sequences of 128 MPDUs with consecutive SNs. It should be noted that embodiments are not limited to usage of bitmaps of 128 bits, however, as any suitable number of bits (such as 64 bits) may be used in some embodiments. As another example, a first MPDU bitmap may be used for a first sequence of the decoded MPDUs for which SNs start at a first starting SN. A second MPDU bitmap may be used for a second sequence of the decoded MPDUs for which SNs start at a second starting SN. The first and second sequences of MPDUs may be of a same TID, in some cases. In some cases, the SNs of the first sequence may be non-overlapping with the SNs of the second sequence. In some cases, the SNs of the first sequence may partly overlap the SNs of the second sequence.

In some embodiments, the MPDU bitmaps may be of a same size, although the scope of embodiments is not limited in this respect. As an example, the sizes of the MPDU bitmaps used in the multi-TID BA message may be the same as an MPDU bitmap size for other BA messages. For instance, such a size may have been determined, such as through simulation, analysis and/or other techniques, to be optimal in some cases.

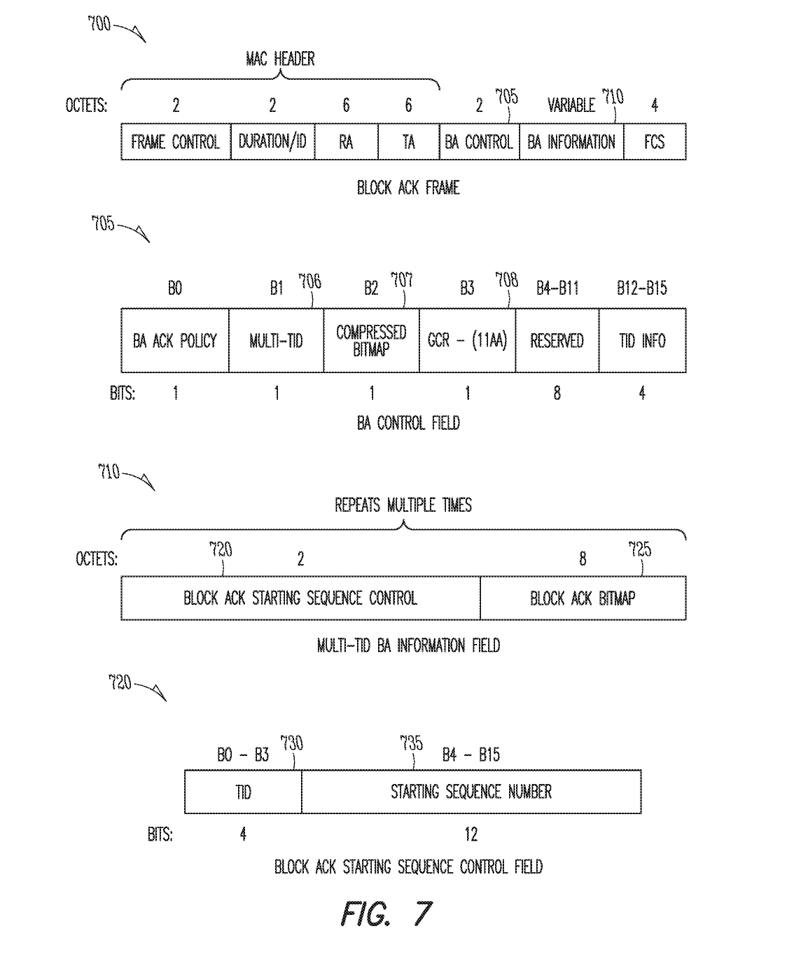

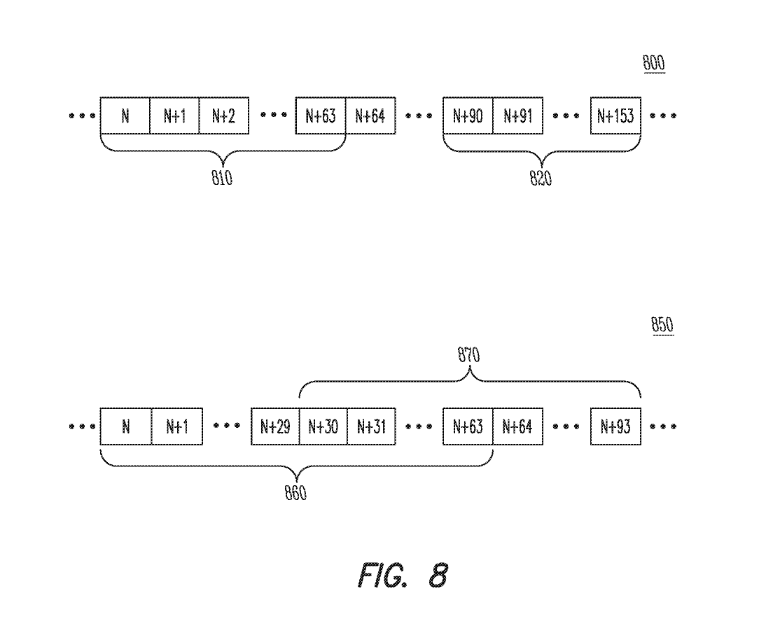

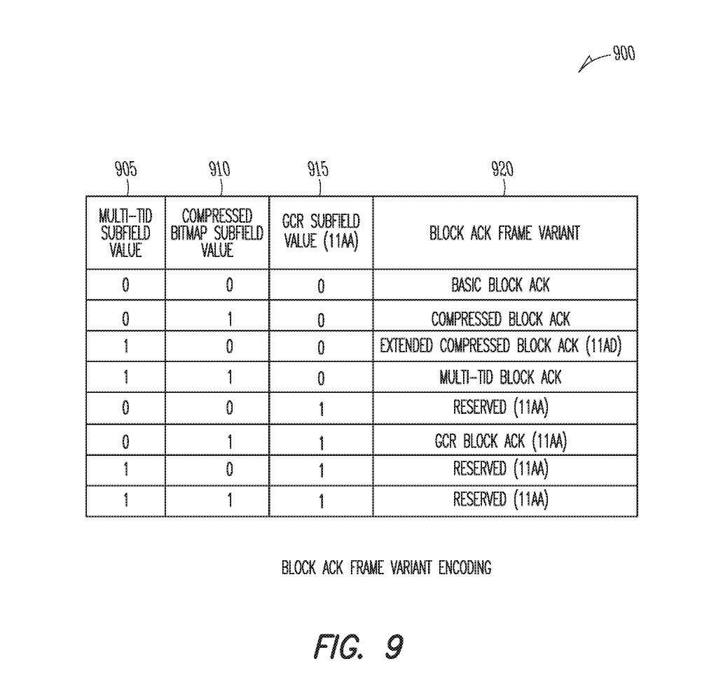

FIG. 7 illustrates examples of Block Acknowledgement (BA) frames and control fields in accordance with some embodiments. FIG. 8 illustrates BA Bitmap examples in accordance with some embodiments. FIG. 9 illustrates examples of BA frame variant encoding in accordance with some embodiments. It should be noted that the examples shown in FIGS. 7-9 may illustrate some or all of the concepts described herein, but the scope of the embodiments is not limited by these examples. In addition, formats, sizes and arrangements of the frames, fields and/or messages as shown in FIGS. 7-9 are also not limiting. Some embodiments may include any or all of the parameters shown in the examples of FIGS. 7-9, and some embodiments may include additional parameters not shown in FIGS. 7-9. Some embodiments may also include other similar parameters in addition to, or instead of, some of those parameters shown in FIGS. 7-9.

The example BA frame 700 may include a BA control field 705 and BA information field 710. The BA control field 705 may include indicators/fields for multi-TID 706, compressed bitmap 707, and GCR 708, examples of which will be presented below in FIG. 9. The BA information field 710 may include one or more pairs of BA Starting Sequence Control fields 720 and BA bitmaps 725. For instance, a first pair may include a first BA Starting Sequence Control field 720 that may include control information for a first BA bitmap 725. Multiple pairs, such as a second, third and/or additional pairs, may be included in the BA information field 710, in some cases. Embodiments are not limited to usage of multiple pairs, however, as a single pair may be used in some cases. In addition, the BA information field 710 may be restricted to include no more than a specified number of pairs, which may or may not be part of a standard. As a non-limiting example, the BA information field 710 may include between 1 and 8 such pairs, in some embodiments. Embodiments are not limited to a maximum of 8 pairs, however, as any such number may be specified in some cases. As an example, the BA starting sequence control field 720 may include a TID 730 and a starting sequence number 735.

Referring to FIG. 8, in a first example scenario 800, a first Bitmap sequence 810 may include 64 MPDUs with SNs ranging from N to N+63 and a second Bitmap sequence 820 may include 64 MPDUs with SNs ranging from N+90 to N+153. The MPDUs in the first and second Bitmap sequences may be of a same TID, in some cases. Accordingly, non-overlapping Bitmap sequences of MPDUs of a same TID may be indicated by a multi-TID BA in the example scenario 800.

In a second example scenario 850, a first Bitmap sequence 860 may include 64 MPDUs with SNs ranging from N to N+63 and a second Bitmap sequence 870 may include 64 MPDUs with SNs ranging from N+30 to N+93. The MPDUs in the first and second Bitmap sequences may be of a same TID, in some cases. Accordingly, overlapping Bitmap sequences of MPDUs of a same TID may be indicated by a multi-TID BA in the example scenario 850.

It should be noted that embodiments are not limited to usage of bitmaps of 64 bits as shown in the example scenarios 800, 850. In some embodiments, techniques illustrated in the example scenarios 800, 850 may be used in accordance with bitmaps of other sizes, such as 128 bits or other suitable size. It should be noted that in the example scenarios 800, 850, usage of multiple sequences of MPDUs for a same TID may enable usage of fixed size bitmaps, in some cases. It should also be noted that in some cases, a multi-TID BA message may include MPDU bitmaps for other TIDs. For instance, a multi-TID BA message may include MPDU bitmaps for sequences 810 and 820 of a first TID and may include another MPDU bitmap for a sequence of MPDUs of a second TID.

Referring to FIG. 9, examples of BA frame variant encoding are presented. The columns 905, 910, and 915 may refer to possible values (different combinations of 0 and 1) that may be used in fields 706, 707, and 708, respectively, of the BA control field (FIG. 7). Accordingly, different types of BAs, such as those shown in column 920, may be indicated in the BA control field 705 (FIG. 7) by appropriate setting of the fields 706-708. For instance, setting of the fields 706-708 to the values of 0, 0, and 0 may indicate that a basic BA is to be used.

In some cases, the multi-TID BA described herein may be an “extended multi-TID BA.” For instance, the extended multi-TID BA may be different from a multi-TID BA that may be included in one or more legacy standards. Some or all techniques described herein may be used as part of an extended multi-TID BA procedure, in some embodiments. As a non-limiting example, referring to FIG. 7, the extended multi-TID BA may be indicated by setting of the fields 706-708 to a designated combination shown as “reserved” in FIG. 7, such as (0, 0, 1), (1, 0, 1) or (1, 1, 1).

It should be noted that the mapping between fields 905-915 to the BA types of column 920 is a non-limiting example. That is, embodiments are not limited to the BA types shown in column 920 and are also not limited to any particular mapping of the values between the BA types in column 920 and the values shown in the fields 905-915. Embodiments are also not limited to the particular fields 905-915 used for the mapping or to the number of fields used in the mapping. That is, more or fewer than 3 fields may be used in some embodiments.

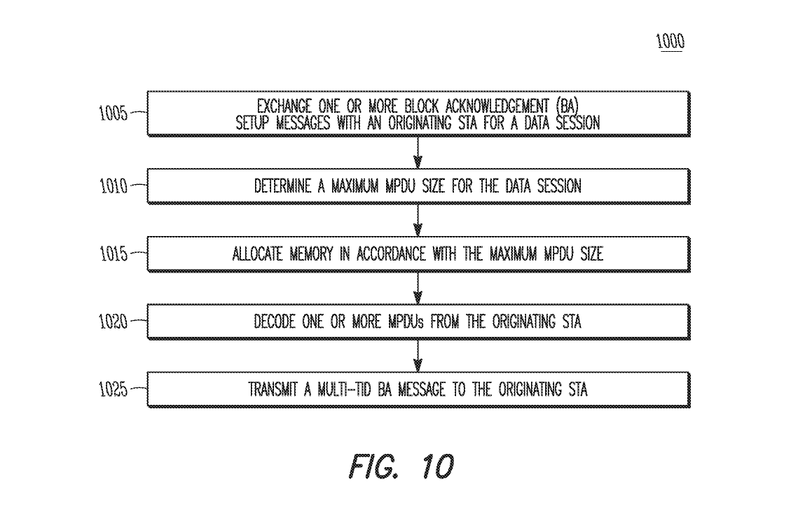

FIG. 10 illustrates the operation of another method of communication in accordance with some embodiments. As mentioned previously regarding the method 400, embodiments of the method 1000 may include additional or even fewer operations or processes in comparison to what is illustrated in FIG. 10 and embodiments of the method 1000 are not necessarily limited to the chronological order that is shown in FIG. 10. In describing the method 1000, reference may be made to FIGS. 1-9, although it is understood that the method 1000 may be practiced with any other suitable systems, interfaces and components. In addition, embodiments of the method 1000 may be applicable to APs 102, STAs 103, UEs, eNBs or other wireless or mobile devices. The method 1000 may also refer to an apparatus for an AP 102, STA 103 and/or other device described above.

It should be noted that the method 1000 may be practiced at a receiving STA 103 and may include exchanging of frames, signals and/or messages with an originating STA 103. Similarly, the method 400 may be practiced at an originating STA 103 and may include exchanging of frames, signals and/or messages with a receiving STA 103. In some cases, operations and techniques described as part of the method 400 may be relevant to the method 1000. In addition, embodiments of the method 1000 may include operations performed at the receiving STA 103 that are reciprocal or similar to other operations described herein performed at the originating STA 103. For instance, an operation of the method 1000 may include reception of a message from the originating STA 103 while an operation of the method 400 may include transmission of the same message or similar message by the originating STA 103.

In addition, previous discussion of various techniques and concepts may be applicable to the method 1000 in some cases, including the originating STA 103, receiving STA 103, BA, BA messages, multi-TID BA messages, BA setup messages, MPDUs, maximum MPDU sizes, negotiation of the BA and/or the maximum MPDU size, MSDUs, PSDUs, MPDU bitmaps, successful reception indicators, memory allocation at the receiving STA 103, LU and/or others. In addition, the examples shown in FIGS. 6-9 may also be applicable, in some cases, although the scope of embodiments is not limited in this respect.

At operation 1005, the receiving STA 103 may exchange one or more BA setup messages with the originating STA 103, including but not limited to BA setup messages such as those described previously. In some embodiments, the receiving STA 103 may receive one or more BA setup messages from the originating STA 103. For instance, a BA setup message may indicate a maximum MPDU size to be used as part of a BA procedure to be used for BA between the receiving STA 103 and the originating STA 103.

The receiving STA may determine the maximum MPDU size at operation 1010. As an example, as previously described, the maximum MPDU size may be indicated in the BA setup message in some cases. As another example, as previously described, the maximum MPDU size may be determined based on parameters included in one or more BA setup messages, such as a maximum MSDU size and/or a maximum number of MSDUs that may be aggregated for inclusion in an MPDU. At operation 1015, the receiving STA 103 may allocate memory in accordance with the maximum MPDU size.

At operation 1020, the receiving STA 103 may decode one or more MPDUs received from the originating STA 103. At operation 1025, the receiving STA 103 may transmit a multi-TID BA message to the originating STA 103. In some embodiments, previously described techniques may be used for the multi-TID BA message, although the scope of embodiments is not limited in this respect.

In Example 1, an apparatus for a station (STA) may comprise memory and processing circuitry. The STA may be configurable to operate as an originating station (STA). The processing circuitry may be configured to generate, for transmission to a receiving STA, a block acknowledgement (BA) setup message that indicates a maximum medium access control (MAC) protocol data unit (MPDU) size for a data session with the receiving STA. The processing circuitry may be further configured to generate, for transmission to the receiving STA and in accordance with the maximum MPDU size, an MPDU that includes an aggregation of one or more MAC service data units (MSDUs). The processing circuitry may be further configured to determine a successful reception indicator for the MPDU based at least partly on an MPDU bitmap included in a BA message from the receiving STA. The maximum MPDU size may be indicated by the BA setup message as part of a negotiation of a BA procedure to be used as part of the data session.

In Example 2, the subject matter of Example 1, wherein the BA setup message may include an Add Block Acknowledgement (ADDBA) Request message. The ADDBA Request message may include a maximum MPDU size Information Element (IE) that includes the maximum MPDU size.

In Example 3, the subject matter of one or any combination of Examples 1-2, wherein the BA setup message may include an Add Traffic Stream (ADDTS) Request message that includes a traffic specification (TSPEC) Information Element (IE). The TSPEC IE may include a maximum MSDU size and a maximum number of MSDUs to be aggregated for inclusion in the MPDU. The maximum MPDU size for the data session may be based at least partly on the maximum MSDU size and the maximum number of MSDUs.

In Example 4, the subject matter of one or any combination of Examples 1-3, wherein the maximum MPDU size may be indicated by the BA setup message to enable memory allocation, at the receiving STA, for MPDUs transmitted by the originating STA in the data session.

In Example 5, the subject matter of one or any combination of Examples 1-4, wherein the processing circuitry may be further configured to generate, for transmission to the receiving STA, a physical layer service data unit (PSDU) that includes an aggregation of the MPDU and one or more other MPDUs.

In Example 6, the subject matter of one or any combination of Examples 1-5, wherein the processing circuitry may include a baseband processor to generate the BA setup message and the MPDU.

In Example 7, the subject matter of one or any combination of Examples 1-6, wherein the apparatus may further include a transceiver to transmit the BA setup message and the MPDU and to receive the BA message.

In Example 8, the subject matter of one or any combination of Examples 1-7, wherein the transceiver may be configured to operate in a millimeter wave (mmWave) frequency range to transmit the BA setup message and the MPDU and to receive the BA message. The originating STA may be arranged to operate in accordance with a wireless local area network (WLAN) protocol.

In Example 9, a non-transitory computer-readable storage medium may store instructions for execution by one or more processors to perform operations for communication by an originating station (STA). The operations may configure the one or more processors to generate, for transmission to a receiving STA, a block acknowledgement (BA) setup message to establish a BA procedure, between the receiving STA and the originating STA, of medium access control (MAC) protocol data units (MPDUs) transmitted by the originating STA as part of a data session. The operations may further configure the one or more processors to aggregate one or more groups of MAC service data units (MSDUs) for inclusion in a group of MPDUs for transmission to the receiving STA as part of the data session. The MSDUs may be aggregated in accordance with a maximum MPDU size indicated in the BA setup message.

In Example 10, the subject matter of Example 9, wherein the group of MPDUs may be aggregated into a physical layer service data unit (PSDU) for the transmission to the receiving STA.

In Example 11, the subject matter of one or any combination of Examples 9-10, wherein the operations may further configure the one or more processors to decode a BA message from the receiving STA that includes an MPDU bitmap of successful reception indicators for at least a portion of the MPDUs in the group. The operations may further configure the one or more processors to generate, for transmission to the receiving STA, a second PSDU that includes a second aggregation of MPDUs that includes an MPDU for which the bitmap of successful reception indicators indicates a reception failure at the receiving STA.

In Example 12, the subject matter of one or any combination of Examples 9-11, wherein the BA setup message may include an Add Block Acknowledgement (ADDBA) Request message. The ADDBA Request message may include a maximum MPDU size Information Element (IE) that includes the maximum MPDU size.

In Example 13, the subject matter of one or any combination of Examples 9-12, wherein the BA setup message may include an Add Traffic Stream (ADDTS) Request message that includes a traffic specification (TSPEC) Information Element (IE). The TSPEC IE may include, for aggregation of MSDUs for MPDUs, a maximum MSDU size and a maximum number of MSDUs for the aggregation. The maximum MPDU size for the data session may be based at least partly on the maximum MSDU size and the maximum number of MSDUs for the aggregation.

In Example 14, the subject matter of one or any combination of Examples 9-13, wherein the maximum MPDU size may be indicated by the BA setup message to enable memory allocation, at the receiving STA, for MPDUs transmitted by the originating STA in the data session.

In Example 15, an apparatus for a station (STA) may comprise memory and processing circuitry. The STA may be configurable to operate as a receiving station (STA). The processing circuitry may be configured to decode a group of medium access control (MAC) protocol data units (MPDUs) from an originating STA. The processing circuitry may be further configured to generate, for transmission to the originating STA, a multiple traffic identifier (multi-TID) block acknowledgement (BA) message to indicate whether the MPDUs have been successfully decoded at the receiving STA. The multi-TID BA message may include a group of MPDU bitmaps of successful reception indicators for sequences of the decoded MPDUs. The multi-TID BA message may further include starting MPDU sequence numbers (SNs) for the MPDU bitmaps. Traffic identifiers (TIDs) of at least a portion of the sequences of the decoded MPDUs may be the same.

In Example 16, the subject matter of Example 15, wherein the TIDs may be based on traffic classes (TCs) of the MPDUs.

In Example 17, the subject matter of one or any combination of Examples 15-16, wherein SNs for the decoded MPDUs of each MPDU bitmap may be consecutive. The MPDU bitmaps in the group may be restricted to a fixed length.

In Example 18, the subject matter of one or any combination of Examples 15-17, wherein a first MPDU bitmap in the group may be for a first sequence of the decoded MPDUs for which SNs start at a first starting SN. A second MPDU bitmap in the group may be for a second sequence of the decoded MPDUs for which SNs start at a second starting SN. The first and second sequences of MPDUs may be of a same TID.

In Example 19, the subject matter of one or any combination of Examples 15-18, wherein the SNs of the first sequence may be non-overlapping with the SNs of the second sequence.

In Example 20, the subject matter of one or any combination of Examples 15-19, wherein the SNs of the first sequence may at least partly overlap the SNs of the second sequence.

In Example 21, the subject matter of one or any combination of Examples 15-20, wherein the apparatus may further include a transceiver to transmit the multi-TID BA message and to receive the MPDUs.

In Example 22, the subject matter of one or any combination of Examples 15-21, wherein the transceiver may be configured to operate in a millimeter wave (mmWave) frequency range to transmit the multi-TID BA message and to receive the MPDUs. The receiving STA may be arranged to operate in accordance with a wireless local area network (WLAN) protocol.

In Example 23, the subject matter of one or any combination of Examples 15-22, wherein the processing circuitry may include a baseband processor to decode the MPDUs and to generate the multi-TID BA message.

In Example 24, a method of communication at a station (STA), configurable to operate as a receiving station (STA), may comprise decoding a block acknowledgement (BA) setup message from an originating STA that indicates a maximum medium access control (MAC) protocol data unit (MPDU) size for a data session with the receiving STA. The method may further comprise allocating memory of the receiving STA in accordance with the maximum MPDU size. The method may further comprise decoding an MPDU from the originating STA that includes an aggregation of one or more MAC service data units (MSDUs). The method may further comprise generating, for transmission to the originating STA, a multiple traffic identifier (multi-TID) BA message that includes a group of one or more MPDU bitmaps. The MPDU bitmaps may indicate whether sequences of decoded MPDUs have been successfully decoded at the receiving STA.

In Example 25, the subject matter of Example 24, wherein the BA setup message may include an Add Block Acknowledgement (ADDBA) Request message. The ADDBA Request message may include a maximum MPDU size Information Element (IE) that includes the maximum MPDU size.

In Example 26, the subject matter of one or any combination of Examples 24-25, wherein the BA setup message may include an Add Traffic Stream (ADDTS) Request message that includes a traffic specification (TSPEC) Information Element (IE). The TSPEC IE may include, for aggregation of MSDUs for MPDUs, a maximum MSDU size and a maximum number of MSDUs for the aggregation. The maximum MPDU size for the data session may be based at least partly on the maximum MSDU size and the maximum number of MSDUs for the aggregation.

In Example 27, an apparatus for a station (STA), configurable to operate as a receiving station (STA), may comprise means for decoding a block acknowledgement (BA) setup message from an originating STA that indicates a maximum medium access control (MAC) protocol data unit (MPDU) size for a data session with the receiving STA. The apparatus may further comprise means for allocating memory of the receiving STA in accordance with the maximum MPDU size. The apparatus may further comprise means for decoding an MPDU from the originating STA that includes an aggregation of one or more MAC service data units (MSDUs). The apparatus may further comprise means for generating, for transmission to the originating STA, a multiple traffic identifier (multi-TID) BA message that includes a group of one or more MPDU bitmaps. The MPDU bitmaps may indicate whether sequences of decoded MPDUs have been successfully decoded at the receiving STA.

In Example 28, the subject matter of Example 27, wherein the BA setup message may include an Add Block Acknowledgement (ADDBA) Request message. The ADDBA Request message may include a maximum MPDU size Information Element (IE) that includes the maximum MPDU size.

In Example 29, the subject matter of one or any combination of Examples 27-28, wherein the BA setup message may include an Add Traffic Stream (ADDTS) Request message that includes a traffic specification (TSPEC) Information Element (IE). The TSPEC IE may include, for aggregation of MSDUs for MPDUs, a maximum MSDU size and a maximum number of MSDUs for the aggregation. The maximum MPDU size for the data session may be based at least partly on the maximum MSDU size and the maximum number of MSDUs for the aggregation.

In Example 30, an apparatus for a station (STA), configurable to operate as an originating station (STA), may comprise means for generating, for transmission to a receiving STA, a block acknowledgement (BA) setup message that indicates a maximum medium access control (MAC) protocol data unit (MPDU) size for a data session with the receiving STA. The apparatus may further comprise means for generating, for transmission to the receiving STA and in accordance with the maximum MPDU size, an MPDU that includes an aggregation of one or more MAC service data units (MSDUs). The apparatus may further comprise means for determining a successful reception indicator for the MPDU based at least partly on an MPDU bitmap included in a BA message from the receiving STA. The maximum MPDU size may be indicated by the BA setup message as part of a negotiation of a BA procedure to be used as part of the data session.

In Example 31, the subject matter of Example 30, wherein the BA setup message may include an Add Block Acknowledgement (ADDBA) Request message. The ADDBA Request message may include a maximum MPDU size Information Element (IE) that includes the maximum MPDU size.

In Example 32, the subject matter of one or any combination of Examples 30-31, wherein the BA setup message may include an Add Traffic Stream (ADDTS) Request message that includes a traffic specification (TSPEC) Information Element (IE). The TSPEC IE may include a maximum MSDU size and a maximum number of MSDUs to be aggregated for inclusion in the MPDU. The maximum MPDU size for the data session may be based at least partly on the maximum MSDU size and the maximum number of MSDUs.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for a station (STA), configurable to operate as an originating station (STA), the apparatus comprising memory and processing circuitry configured to:
generate, for transmission to a receiving STA, a block acknowledgement (BA) setup message that indicates a maximum medium access control (MAC) protocol data unit (MPDU) size for a data session with the receiving STA;
generate, for transmission to the receiving STA and in accordance with the maximum MPDU size, an MPDU that includes an aggregation of one or more MAC service data units (MSDUs); and
determine a successful reception indicator for the MPDU based at least partly on an MPDU bitmap included in a BA message from the receiving STA,
wherein the maximum MPDU size is indicated by the BA setup message as part of a negotiation of a BA procedure to be used as part of the data session.

2. The apparatus according to claim 1, wherein:
the BA setup message includes an Add Block Acknowledgement (ADDBA) Request message, and
the ADDBA Request message includes a maximum MPDU size Information Element (IE) that includes the maximum MPDU size.

3. The apparatus according to claim 1, wherein:
the BA setup message includes an Add Traffic Stream (ADDTS) Request message that includes a traffic specification (TSPEC) Information Element (IE),
the TSPEC IE includes a maximum MSDU size and a maximum number of MSDUs to be aggregated for inclusion in the MPDU, and
the maximum MPDU size for the data session is based at least partly on the maximum MSDU size and the maximum number of MSDUs.

4. The apparatus according to claim 1, wherein the maximum MPDU size is indicated by the BA setup message to enable memory allocation, at the receiving STA, for MPDUs transmitted by the originating STA in the data session.

5. The apparatus according to claim 1, the processing circuitry further configured to generate, for transmission to the receiving STA, a physical layer service data unit (PSDU) that includes an aggregation of the MPDU and one or more other MPDUs.

6. The apparatus according to claim 1, wherein the processing circuitry includes a baseband processor to generate the BA setup message and the MPDU.

7. The apparatus according to claim 1, wherein the apparatus further includes a transceiver to transmit the BA setup message and the MPDU and to receive the BA message.

8. The apparatus according to claim 7, wherein:
the transceiver is configured to operate in a millimeter wave (mmWave) frequency range to transmit the BA setup message and the MPDU and to receive the BA message, and
the originating STA is arranged to operate in accordance with a wireless local area network (WLAN) protocol.

9. A non-transitory computer-readable storage medium that stores instructions for execution by one or more processors to perform operations for communication by an originating station (STA), the operations to configure the one or more processors to:
generate, for transmission to a receiving STA, a block acknowledgement (BA) setup message to establish a BA procedure, between the receiving STA and the originating STA, of medium access control (MAC) protocol data units (MPDUs) transmitted by the originating STA as part of a data session; and
aggregate one or more groups of MAC service data units (MSDUs) for inclusion in a group of MPDUs for transmission to the receiving STA as part of the data session,
wherein the MSDUs are aggregated in accordance with a maximum MPDU size indicated in the BA setup message.

10. The non-transitory computer-readable storage medium according to claim 9, wherein the group of MPDUs are aggregated into a physical layer service data unit (PSDU) for the transmission to the receiving STA.

11. The non-transitory computer-readable storage medium according to claim 10, the operations to further configure the one or more processors to:
decode a BA message from the receiving STA that includes an MPDU bitmap of successful reception indicators for at least a portion of the MPDUs in the group; and
generate, for transmission to the receiving STA, a second PSDU that includes a second aggregation of MPDUs that includes an MPDU for which the bitmap of successful reception indicators indicates a reception failure at the receiving STA.

12. The non-transitory computer-readable storage medium according to claim 9, wherein:
the BA setup message includes an Add Block Acknowledgement (ADDBA) Request message, and
the ADDBA Request message includes a maximum MPDU size Information Element (IE) that includes the maximum MPDU size.

13. The non-transitory computer-readable storage medium according to claim 9, wherein:
the BA setup message includes an Add Traffic Stream (ADDTS) Request message that includes a traffic specification (TSPEC) Information Element (IE),
the TSPEC IE includes, for aggregation of MSDUs for MPDUs, a maximum MSDU size and a maximum number of MSDUs for the aggregation, and
the maximum MPDU size for the data session is based at least partly on the maximum MSDU size and the maximum number of MSDUs for the aggregation.

14. The non-transitory computer-readable storage medium according to claim 9, wherein the maximum MPDU size is indicated by the BA setup message to enable memory allocation, at the receiving STA, for MPDUs transmitted by the originating STA in the data session.

15. An apparatus for a station (STA), configurable to operate as a receiving station (STA), the apparatus comprising memory and processing circuitry configured to:
decode a group of medium access control (MAC) protocol data units (MPDUs) from an originating STA; and
generate, for transmission to the originating STA, a multiple traffic identifier (multi-TID) block acknowledgement (BA) message to indicate whether the MPDUs have been successfully decoded at the receiving STA,
wherein the multi-TID BA message includes a group of MPDU bitmaps of successful reception indicators for sequences of the decoded MPDUs,
wherein the multi-TID BA message further includes starting MPDU sequence numbers (SNs) for the MPDU bitmaps,
wherein traffic identifiers (TIDs) of at least a portion of the sequences of the decoded MPDUs are the same.

16. The apparatus according to claim 15, wherein the TIDs are based on traffic classes (TCs) of the MPDUs.

17. The apparatus according to claim 15, wherein:
SNs for the decoded MPDUs of each MPDU bitmap are consecutive, and
the MPDU bitmaps in the group are restricted to a fixed length.

18. The apparatus according to claim 17, wherein:
a first MPDU bitmap in the group is for a first sequence of the decoded MPDUs for which SNs start at a first starting SN,
a second MPDU bitmap in the group is for a second sequence of the decoded MPDUs for which SNs start at a second starting SN, and
the first and second sequences of MPDUs are of a same TID.

19. The apparatus according to claim 18, wherein the SNs of the first sequence are non-overlapping with the SNs of the second sequence.

20. The apparatus according to claim 18, wherein the SNs of the first sequence at least partly overlap the SNs of the second sequence.

21. The apparatus according to claim 15, wherein the apparatus further includes a transceiver to transmit the multi-TID BA message and to receive the MPDUs.

22. The apparatus according to claim 21, wherein
the transceiver is configured to operate in a millimeter wave (mmWave) frequency range to transmit the multi-TID BA message and to receive the MPDUs, and
the receiving STA is arranged to operate in accordance with a wireless local area network (WLAN) protocol.

23. The apparatus according to claim 15, wherein the processing circuitry includes a baseband processor to decode the MPDUs and to generate the multi-TID BA message.

24. A method of communication at a station (STA), configurable to operate as a receiving station (STA), the method comprising:
decoding a block acknowledgement (BA) setup message from an originating STA that indicates a maximum medium access control (MAC) protocol data unit (MPDU) size for a data session with the receiving STA;
allocating memory of the receiving STA in accordance with the maximum MPDU size;
decoding an MPDU from the originating STA that includes an aggregation of one or more MAC service data units (MSDUs); and
generating, for transmission to the originating STA, a multiple traffic identifier (multi-TID) BA message that includes a group of one or more MPDU bitmaps,
wherein the MPDU bitmaps indicate whether sequences of decoded MPDUs have been successfully decoded at the receiving STA.

25. The method according to claim 24, wherein:
the BA setup message includes an Add Block Acknowledgement (ADDBA) Request message, and
the ADDBA Request message includes a maximum MPDU size Information Element (IE) that includes the maximum MPDU size.

26. The method according to claim 24, wherein:
the BA setup message includes an Add Traffic Stream (ADDTS) Request message that includes a traffic specification (TSPEC) Information Element (IE),
the TSPEC IE includes, for aggregation of MSDUs for MPDUs, a maximum MSDU size and a maximum number of MSDUs for the aggregation, and
the maximum MPDU size for the data session is based at least partly on the maximum MSDU size and the maximum number of MSDUs for the aggregation.
